(19) United States
(12) Patent Application Publication
(10) Pub. No.: US 2006/0079328 A1
(43) Pub. Date: Apr. 13, 2006

(54) Light-emitting game controller

(76) Inventor: Rocky Wang, Chung-Ho City (TW)

Correspondence Address: FROMMER LAWRENCE & HAUG, 745 FIFTH AVENUE- 10TH FL., NEW YORK, NY, 10151, US

(21) Appl. No.: 11/108,935

(22) Filed: Apr. 19, 2005

(30) Foreign Application Priority Data
Oct. 12, 2004 (TW) 093216150

(51) Int. Cl. A63F 13/00

(52) U.S. Cl. 463/37

(57) ABSTRACT

A game controller, which is used in conjunction with a game device, includes a housing, a light-emitting device provided within the housing for producing flashing light of varying intensity, and a circuitry provided within the housing and generating control signals in response to signals received from the game device to control the intensity and the flashing frequency of the light emitted by the light-emitting device.

### CROSS-REFERENCE TO RELATED APPLICATION

This application claims priority from Taiwanese Utility Application No. 93216150, filed on Oct. 12, 2004.

### BACKGROUND OF THE INVENTION

1. Field of the Invention

The invention relates to a light-emitting game controller and more particularly to a light-emitting game controller, which emits light with different flashing frequencies and intensities according to signals from a game device, so as to provide more stunning and dynamic visual effects in the virtual environment when playing games.

2. Description of the Related Art

Games are generally classified as games executed in computers, games executed in portable (or hand-held) game machines, and games executed in video game machines. No matter what devices are used for playing games, game controllers are indispensable elements in these devices. It is known in the art that some game controllers are provided therein with vibration devices for vibrating the controllers according to signals received from computers or game machines. By such an arrangement, the vibration of the controllers matches the scenario and the audio effects of the game being played by users, thereby increasing realism when playing games. However, there is still a need for a game controller provided with a light-emitting device for producing light with varying intensity and flashing frequency to match the scenario of the game being played by users, thereby resulting in stunning video effects when playing games.

### SUMMARY OF THE INVENTION

Therefore, the object of the present invention is to provide a game controller with a light-emitting device for producing light of varying intensity and flashing frequency to match the contents or scenario of the game being played by users, thereby resulting in enhanced video effects when playing games.

According to the present invention, a game controller is to be used in conjunction with a game device, and comprises a housing, a light-emitting device provided within the housing for producing flashing light of varying intensity, and a circuitry provided within the housing and generating control signals in response to signals received from the game device to control the intensity and the flashing frequency of the light emitted by the light-emitting device.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram showing the structure of the game controller embodying this invention, in together with a game device;

FIG. 2 is a schematic top view of an example of the game controller which is configured as a joystick;

FIG. 3 is a schematic bottom view of the game controller of FIG. 2;

FIG. 4 is a schematic exploded perspective view of another example of the game controller which is configured as a keyboard; and

FIG. 5 is a schematic exploded perspective view of still another example of the game controller which is configured as a mouse.

### DETAILED DESCRIPTION OF THE PREFERRED EMBODIMENTS

Before the present invention is described in greater detail, it should be noted that like elements are denoted by the same reference numerals throughout the disclosure.

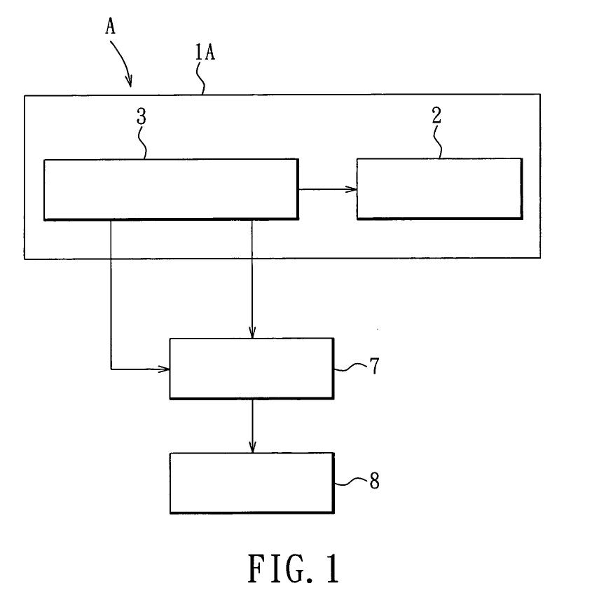

As shown in FIG. 1, a game controller (A) embodying the present invention is used with a game device 7, such as computers or video game machines. The game controller (A) comprises a housing (1A), a light-emitting device 2 provided within the housing (1A) and a circuitry 3 provided within the housing (1A) to control the light-emitting device 2 in terms of flashing frequency and intensity of light. When a game is played using the game controller (A) connected to the game device 7, the circuitry 3 of the game controller (A) generates output signals to the game device 7 in response to a user input. The game device 7, which comprises a microprocessor, executes a game program contained therein according to the output signals from the game controller (A) and is connected to the display unit 8 for showing the virtual scenario of the game. When the virtual scenario of the game requires light-flashing or changes in the intensity of light to enhance the virtual environment, the game device 7 generates a feedback signal. Then, in response to the feedback signal, the circuitry 3 generates control signals to control the intensity and the flashing frequency of light emitted by the light-emitting device 2.

According to this invention, the game controller (A) may be configured as a joystick, a keyboard or a mouse.

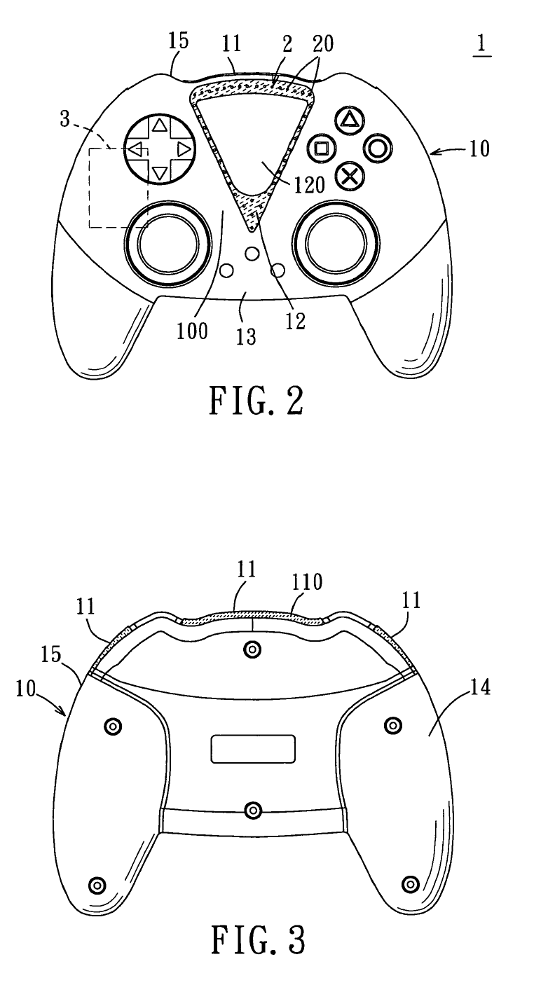

FIGS. 2 and 3 show a joystick 1 incorporating the present invention, which includes a housing 10 composed an opaque upper wall 13, a lower wall 14 and a side wall 15 interconnecting the upper wall 13 and the lower wall 14. The upper wall 13 includes a substantially triangular opaque part 120 at the center portion 100 thereof and adjacent to the side wall 15 at the front of the housing 10. A transparent part 12 is provided along the perimeter of the substantially triangular opaque part 120. The side wall 15 at the front of the housing 10 includes a plurality of lateral transparent parts 11 adjacent to the lower wall 14 for passage of the light emitted by the light-emitting device 2.

The light-emitting device 2 includes a plurality of light-emitting elements 20 located at positions corresponding to the positions of the transparent parts 11 of the side wall 15 and the transparent part 12 of the upper wall 13, whereby the light emitted from the light-emitting elements 20 passes through the transparent parts 11 of the side wall 15 and the transparent part 12 of the upper wall 13.

The light-emitting elements 20 preferably are LEDs. More preferably, each LED is capable of changing the color of the light emitted therefrom. Alternatively, a plurality of LEDs each emitting light of a different color may be used, so as to generate colorful light from the light-emitting device 2. The circuitry 3 (shown in dotted line) is provided within the housing 10 and is connected to the light-emitting elements 20 so as to control not only the flashing frequency and intensity of the light but also the color of the light emitted from the light-emitting elements 20, according to the scenario of the game.

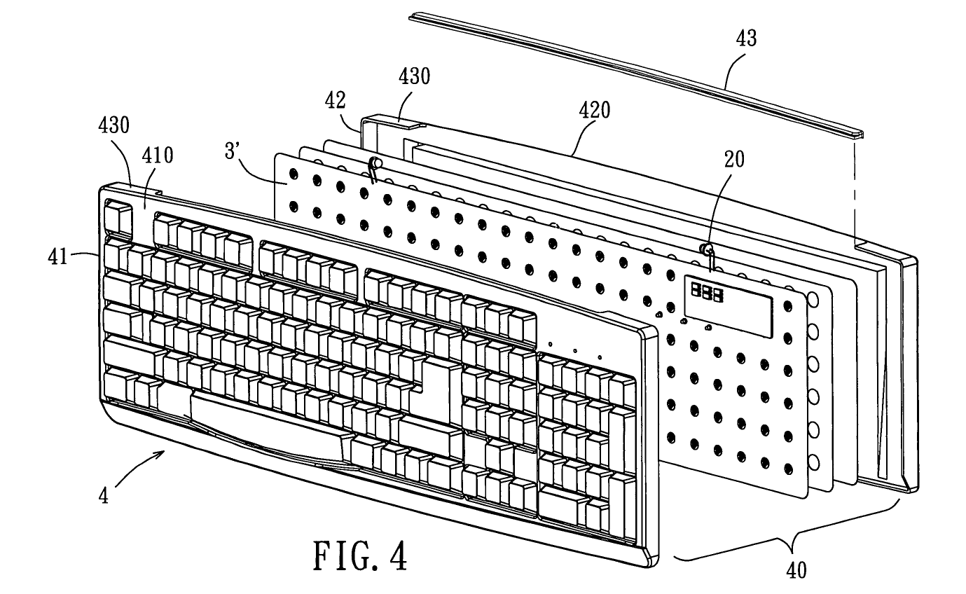

When it is intended to execute educational programs for teaching children or to train children to implement computer programs, the game controller (A) of this invention may be configured as a mouse or a keyboard. Referring to FIG. 4, there is shown a keyboard 4 which includes a housing 40 formed of an upper housing half 41 and a lower housing half 42 so that the housing 40 has a lower side 420, an upper side 410, and a lateral side 430 extending between the lower side 420 and the upper side 410. A transparent part 43 is provided at the lateral side 430. The circuitry 3′ is provided within the housing 40. The light emitting elements 20, such as LEDs, are received in the housing 40, and are connected to the circuitry 3′ adjacent to the transparent part 43 so that the light emitted therefrom passes through the transparent part 43 of the housing 40.

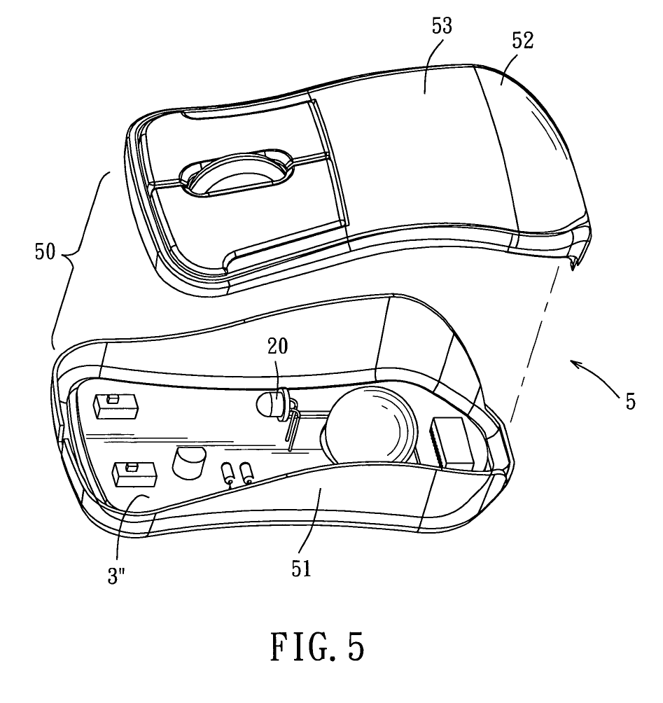

Referring to FIG. 5, a mouse 5 is shown to include a housing 50 which has a lower housing half 51 and an upper housing half 52 with a transparent part 53. The circuitry 3″ is provided within the lower housing half 51. The light-emitting element 20, such as an LED, is provided within the housing 50 under the transparent part 53 of the upper housing half 52 so as to allow the passage of the light emitted therefrom through the transparent part 53 of the housing 50.

The upper housing half 52 may be entirely transparent, and the lower housing half 51 may also be entirely transparent, so as to allow the passage of the light from the light emitting element 20 through the upper and lower housing halves 52 and 51.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A game controller adapted for use with a game device, comprising:
a housing;
a light-emitting device provided within said housing for producing flashing light of varying intensity; and
a circuitry provided within said housing and generating control signals in response to signals received from the game device to control the intensity and the flashing frequency of the light emitted by said light-emitting device.

2. The game controller according to claim 1, wherein said circuitry further generates output signals to the game device in response to a user input.

3. The game controller according to claim 1, wherein said housing has at least one transparent part for passage of the light emitted by said light-emitting device.

4. The game controller according to claim 3, wherein the game controller is configured as a joystick, and said housing includes an upper wall, a lower wall, and a side wall interconnecting said upper and lower walls, said upper wall including a substantially triangular opaque part adjacent to said side wall, said transparent part being provided along the perimeter of said substantially triangular opaque part.

5. The game controller according to claim 4, wherein said side wall includes a lateral transparent part adjacent to said lower wall for passage of the light emitted by said light-emitting device.

6. The game controller according to claim 5, wherein said light-emitting device includes a plurality of light-emitting elements located at positions corresponding to said lateral transparent part of said side wall and said transparent part of said upper wall.

7. The game controller according to claim 3, wherein the game controller is configured as a mouse, and said housing has a lower housing half, and an upper housing half having said transparent part.

8. The game controller according to claim 3, wherein the game controller is configured as a keyboard, and said housing has a lower side, an upper side, and a lateral side extending between said lower and upper sides, said transparent part being provided at said lateral side.
